(19) United States
(12) Patent Application Publication
(10) Pub. No.: US 2025/0251286 A1
(43) Pub. Date: Aug. 7, 2025

(54) SENSOR ASSEMBLY

(71) Applicants: Jiabin YU, ZHONGSHAN (CN); Shenzhen Sunricher Technology Co., Ltd., Shenzhen (CN)

(72) Inventors: Fei GONG, Shenzhen (CN); Jiabin YU, Zhongshan (CN)

(73) Assignee: Shenzhen Sunricher Technology Co., Ltd., Shenzhen (CN)

(21) Appl. No.: 18/673,527

(22) Filed: May 24, 2024

(30) Foreign Application Priority Data
Feb. 4, 2024 (CN) 202410159968.2

(51) Int. Cl. G01J 5/04; G01J 5/02

(52) U.S. Cl. CPC G01J 5/04; G01J 5/025

(57) ABSTRACT

A sensor assembly, including a sensor body and a connector. The sensor includes: a first casing, a cover plate, and a first signal piece. The connector includes: a second casing and second signal piece. The first casing defines therein a first accommodation chamber. The cover plate is installed at an end of the first casing. The first signal piece is arranged in the first accommodation chamber, and the cover plate defines therein a mounting hole in communication with the first accommodation chamber. The second signal piece is arranged on the second casing, and the second casing is arranged in the mounting hole and is in detachable connection with the cover plate. The first signal piece contacts with the second signal piece.

### CROSS-REFERENCE TO RELATED APPLICATIONS

Pursuant to 35 U.S.C. § 119 and the Paris Convention, this application claims the benefit of Chinese Patent Application No. 202410159968.2 filed Feb. 4, 2024, the contents of which are incorporated herein by reference.

### TECHNICAL FIELD

The present application relates to the field of intelligent sensing technology, more particularly to a sensor assembly.

### BACKGROUND

A typical sensor is designed to have a connector (such as the headphone port connector or 3-PIN connector) and a sensor body integrated into a whole body, thus one sensor may only have one type of connector, which cannot be change after manufacture. In other words, users cannot adjust or replace the connector as needed during use. When the type of the connector does not correspond with the circuit, matching connection or conversion cannot be realized, which results in inconvenience in the use of the product as well as product waste to a certain extent.

### SUMMARY

It is an object of embodiments of the present application to provide a sensor assembly, aiming at solving the technical problem that the connector in the existing sensor is unable to be replaced or adjusted, resulting in inconvenience in use and product waste.

To achieve the object, a sensor assembly is provided. The sensor assembly comprises a sensor body and a connector. The sensor body comprises: a first casing, a cover plate, and a first signal piece. The connector comprises: a second casing and second signal piece. The first casing defines therein a first accommodation chamber.

The cover plate is installed at an end of the first casing. The first signal piece is arranged in the first accommodation chamber, and the cover plate defines therein a mounting hole in communication with the first accommodation chamber. The second signal piece is arranged on the second casing, and the second casing is arranged in the mounting hole and is in detachable connection with the cover plate. The first signal piece contacts with the second signal piece.

In an embodiment, a support plate is formed at a bottom of the mounting hole, a pressing block is formed on an inner peripheral wall of the mounting hole, and a through hole is formed in the support plate at a position corresponding to the pressing block. An end surface of the second casing facing the first casing is provided with a protrusion portion extending radially outwards. A protrusion portion presses against a surface of a side of the pressing block facing the first signal piece, and the end surface of the second casing is in contact with a surface of a side of the support plate away from the first signal piece.

In an embodiment, a distance between the surface of the side of the pressing block facing the first signal piece and the surface of the side of the support plate away from the first signal piece is defined as D, a distance between a surface of a side of the protrusion portion facing the pressing block and the end surface of the second casing is defined as H, and D is greater than or equal to H.

In an embodiment, the surface of the side of the pressing block facing the first signal piece is aligned with the surface of the side of the support plate away from the first signal piece; or alternatively, the distance between the surface of the side of the pressing block facing the first signal piece and the surface of the side of the support plate away from the first signal piece is greater than 0 and smaller than a height of the protrusion portion.

In an embodiment, a recess is formed on the surface of the side of the pressing block facing the first signal piece, a bulge is formed on the protrusion portion, and the bulge is adapted to be accommodated within the recess.

In an embodiment, along a tightening rotation direction of the second casing, a front surface of the bulge forms an inclined guide surface, and a rear surface of the bulge forms a stop surface.

In an embodiment, a convex ring is arranged on an outer peripheral wall of the second casing, and the convex ring, and a first sealing ring is arranged in a space enclosed by the convex ring, the pressing block, and an inner peripheral wall of the mounting hole.

In an embodiment, an outer peripheral wall of the second casing is provided with a connecting portion arranged outside the cover plate, and a second sealing ring is arranged between the connecting portion and an upper surface of the cover plate; or alternatively, a third sealing ring is arranged between an outer peripheral wall of the cover plate and an inner peripheral wall of a top of the first accommodation chamber.

In an embodiment, a side of the second casing facing the first casing defines therein a second accommodation chamber, the connector further comprises a fixing plate, and the fixing plate is detachably installed in the second accommodation chamber; and the fixing plate is defines therein one or more fixing holes to allow the second signal piece to pass through.

In an embodiment, the sensor body further comprises: a power board, an induction control board, and a sensor; the power board, the induction control board, and the sensor are arranged in the first accommodation chamber; and the first signal piece is in electrical connection with the power board, the sensor is in electrical connection with the induction control board, and the induction control board is in electrical connection with the power board.

Beneficial effects of the sensor assembly provided by embodiments of this application are summarized as follows:

In the sensor assembly provided by embodiments of the present application, the mounting hole is defined in the cover plate of the sensor body, the second casing of the connector is arranged in the mounting hole and is in detachable connection with the cover plate, and the first signal piece of the sensor body is in contact with the second signal piece, such that both the detachable connection of the connector and the transmission of signals can be realized. As the connector of the sensor assembly is detachable, the connectors of different models and specifications are only required to have a same second casing that can be in detachable connection with the mounting hole of the cover plate, in this way, the connectors of different models and specifications can be converted and selected, which is convenient for the users to use in different situations, avoid product waste and idleness, reduce user costs, and save resources.

### BRIEF DESCRIPTION OF THE DRAWINGS

In order to more clearly illustrate the technical solutions in the embodiments of the present application, the drawings that need to be used in the description of the embodiments will be briefly described hereinbelow. Obviously, the accompanying drawings in the following description are only some embodiments of the present application. For those skilled in the art, other drawings can be obtained based on these drawings without creative work.

FIG. 1 is a schematic structural diagram of a sensor assembly provided in an embodiment of the present application, in which, a 3-PIN connector is included;

FIG. 2 is another schematic structural diagram of a sensor assembly provided in an embodiment of the present application, in which, an earphone port connector is included;

FIG. 3 is a perspective exploded schematic diagram of a sensor body in the sensor assembly provided in an embodiment of the present application;

FIG. 4 is a schematic diagram of a cover plate in a sensor assembly provided in an embodiment of the present application from a view angle;

FIG. 5 is a schematic diagram of a cover plate in a sensor assembly provided in an embodiment of the present application from another view angle;

FIG. 6 is a perspective exploded schematic diagram of a 3-PIN connector in a sensor assembly provided in an embodiment of the present application;

FIG. 7 is a perspective exploded schematic diagram of an earphone port connector in a sensor assembly provided in an embodiment of the present application;

FIG. 8 is a schematic structural diagram of a second casing in a sensor assembly provided in an embodiment of the present application;

FIG. 9 is a cross-sectional schematic structural diagram of a cover plate and a second casing fitting each other in a sensor assembly provided in an embodiment of the present application;

FIG. 10 is cross-sectional schematic structural diagram of a protrusion portion in a sensor assembly provided in an embodiment of the present application; and

FIG. 11 is a dimensional schematic diagram of a cover plate and a second casing fitting each other in a sensor assembly provided in an embodiment of the present application.

The following reference numerals are adopted:
100: Sensor assembly; 1: Sensor body; 11: First casing; 110: First accommodation chamber; 12: Cover plate; 120: Mounting hole; 121: Pressing block; 1210: Recess; 122: Support plate; 1220: Through hole; 1221: Strip hole; 123: Concave ring; 13: First signal piece; 14: Power board; 15: Infrared control board; 16: Pyroelectric infrared sensor; 171: Fresnel lens; 172: Lens pressing piece; 181: Bluetooth control board; 182: Indicator light; 183: Photosensitive sensor; 191: First connecting piece; 192: Second connecting piece; 2: Connector; 21: Second casing; 210: Second accommodation chamber; 211: Protrusion portion; 2110: Bulge; 2111: Guide surface; 2112: Stop surface; 212: Convex ring; 213: Connecting portion; 214: Fixing column; 2140: Threaded hole; 22: Second signal piece; 23: Fixing plate; 230: Adapting hole; 231: Fixing hole; 3: First sealing ring; 4: Second sealing ring; and 5: Third sealing ring.

### DETAILED DESCRIPTION OF THE EMBODIMENTS

In order to make the purposes, technical solutions, and advantages of the present application clearer and more understandable, the present application will be further described in detail hereinafter with reference to the accompanying drawings and embodiments. It should be understood that the embodiments described herein are only intended to illustrate but not to limit the present application.

It should be noted that when an element is described as “fixed” or “arranged” on/at another element, it means that the element can be directly or indirectly fixed or arranged on/at another element. When an element is described as “connected” to/with another element, it means that the element can be directly or indirectly connected to/with another element. Terms like “upper”, “lower”, “left”, and “right” that indicate orientation or positional relationship are based on the orientation or the positional relationship shown in the drawings, and are merely for facilitating and simplifying the description of the present application, rather than indicating or implying that a device or component must have a particular orientation, or be configured or operated in a particular orientation, and thus should not be construed as limiting the application. It should be understand that terms like “first” and “second” are only used for the purpose of description, and will in no way be interpreted as indication or hint of relative importance or implicitly indicate the number of the referred technical features. “Multiple”/“a plurality of” refers to the number of two or more than two, unless otherwise clearly and specifically defined.

In order to illustrate the technical solution described in the present application, a detailed description will be given below with reference to specific drawings and embodiments.

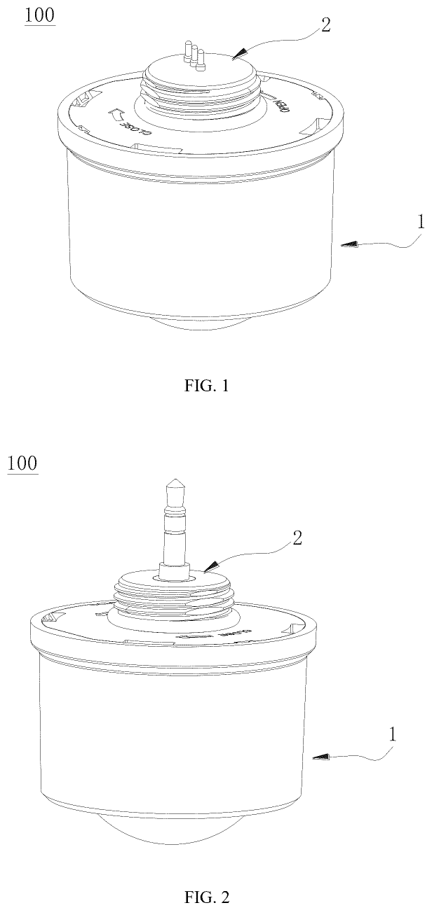

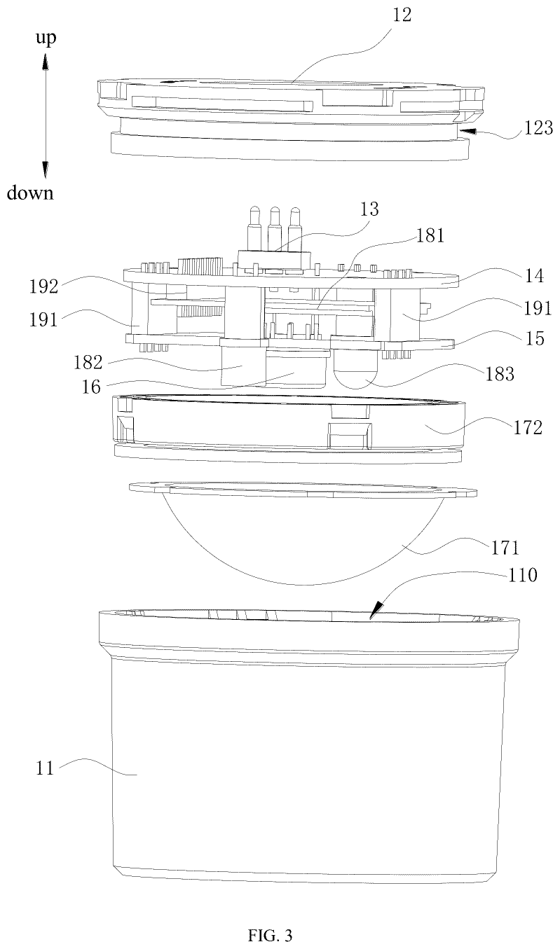

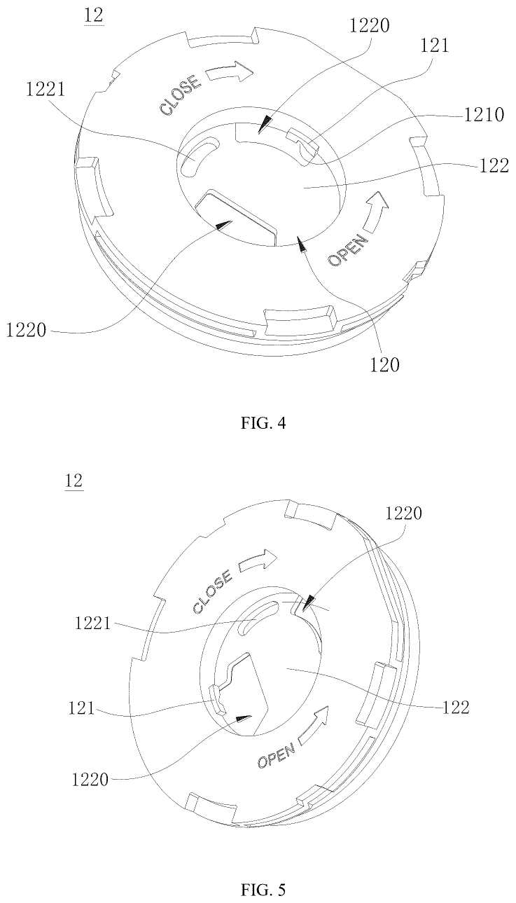

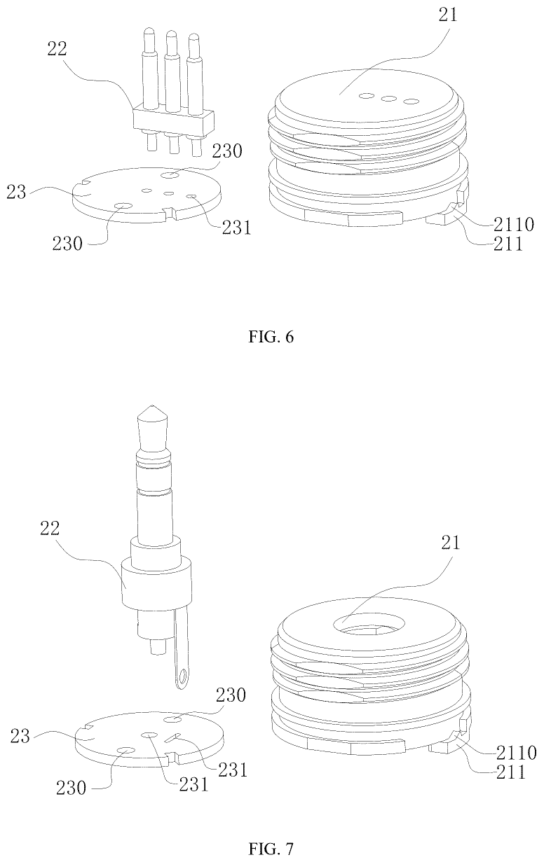

Referring to FIGS. 1, 2, 6, and 7, embodiments of the present application provide a sensor assembly 100, which includes a sensor body 1 and a connector 2. As shown in FIGS. 3-4, the sensor body 1 includes: a first casing 11, a cover plate 12, and a first signal piece 13. The first casing 11 adopts a hollow structure and defines therein a first accommodation chamber 110. An end of the first casing 11 is designed to have an opening, and the cover plate 12 is installed at the opening at the end of the first casing 11. The first signal piece 13 is arranged in the first accommodation chamber, and the cover plate 12 defines therein a mounting hole 20 in communication with the first accommodation chamber, as shown in FIGS. 4 and 5. Correspondingly, referring to FIGS. 6-7, the connector 2 includes a second casing 21 and a second signal piece 22, and the second signal piece 22 is arranged on the second casing 21. As shown in FIG. 9, the second casing 21 is arranged in the mounting hole 120 and is in detachable connection with the cover plate 12, in addition, by arranging the size of the second casing 21, the position of the second signal piece 22 on the second casing 21, and the position of the first signal piece 13 in the first accommodation chamber, it can be relatively easily realized that when the second casing 21 is installed in place, the first signal piece 13 and the second signal piece 22 form physical contact, thereby achieving electrical contact.

In the sensor assembly 100 provided by embodiments of the present application, the mounting hole 120 is defined in the cover plate 12 of the sensor body 1, the second casing 21 of the connector 2 is arranged in the mounting hole 120 and is in detachable connection with the cover plate 12, and the first signal piece 13 of the sensor body 1 is in contact with the second signal piece 22, such that both the detachable connection of the connector 2 and the transmission of signals can be realized. As the connector 2 of the sensor assembly 100 is detachable, the connectors 2 of different models and specifications are only required to have a same second casing 21 that can be in detachable connection with the mounting hole 120 of the cover plate 12, in this way, the connectors 2 of different models and specifications can be converted and selected, which is convenient for the users to use in different situations, avoid product waste and idleness, reduce user costs, and save resources.

For the convenience of description and understanding hereinbelow, based on the situation that the first casing 11 is a hollow structure and the second casing 21 is arranged at one end, “axial”, “circumferential”, and “radial” are defined. Specifically, “axial” is generally defined as a connecting line from a center of the first accommodation chamber to the second signal piece 22, and “radial” and “circumferential” can be determined accordingly. It can be understood that in some embodiments, the first casing 11 is not in a regular shape, or alternatively, the first signal piece 13 and the second signal piece 22 may be connected in a bending manner, so the sensor assembly 100 may not be required to have a very precise axial direction or radial direction.

In addition, for the convenience of description and understanding, based on the above definition of “axial direction”, a direction along the axial direction facing towards the second signal piece 22 is defined as “up”, and a direction along the axial direction facing towards the first signal piece 13 is defined as “down”, as shown in the FIG. 2.

Referring to FIGS. 1-2 in accompany with FIGS. 6-7, the second signal piece 22 is specifically installed on the second casing 21 and penetrates through the second casing 21, and when the second casing 21 is installed in the mounting hole 120, one end of the second signal piece 22 protrudes from the second casing 21, that is, protrudes from the first casing 11, in order to connect with another external structure, thereby realizing signal transmission between the external structure and the first signal piece 13 of the first casing 11.

The first casing 11, the second casing 21, the cover plate 12, and the like can be made of plastic materials, for example, by integrated injection molding, and can be insulated from other electronic components, such as the first signal piece 13, the second signal piece 22, and the like.

The specific models and specifications as referred to in “connector 2 of different models and specifications” are not limited, and can be any connector 2 that needs to establish signal transmission with the sensor body 1.

Connectors 2 of different models and specifications have substantially the same second casings 21. In other words, for the connectors 2 of different models and specifications, at least a portion of each of the second casings 21 that is adapted to the mounting hole 120 of first casing 11 may adopt the same structure, while portions of the second casings 21 that are adapted to different second signal pieces 22 may adopt different structures.

The connector 2 can be a 3-PIN (3-probe) connector, as shown in FIG. 6, and the connector can also be a headphone port connector, as shown in FIG. 7. Hereinbelow, taking the sensor body 1 combined with the 3-PIN connector and the headphone port connector respectively as an example, the specific structure of the connector 2 and the connection method between the connector 2 and the cover plate 12 will be explained in detail.

For the detachable connection between first casing 11 and second casing 21, a first implementation method is provided as follows:

Referring to FIGS. 4, 5 and 9, a support plate 122 is formed at a bottom of the mounting hole 120, a pressing block 121 is formed on an inner peripheral wall of the mounting hole 120, and a through hole 1220 is formed in the support plate 122 at a position corresponding to the pressing block 121 and is in communication with the first accommodation chamber, as shown in FIGS. 6, 7 and 9. An end surface (lower end surface) of the second casing 21 facing the first accommodation chamber is provided with a protrusion portion 211 extending radially outward. The protrusion portion 211 presses against a side (lower side) of the pressing block 121 that faces the first signal piece 13, and a lower end surface of the second casing 21 is in contact with an upper surface of the support plate 122. As shown in FIG. 11, the second signal piece 22 passes through the support plate 122 via the through hole 1220 and forms a connection with the first signal piece 13.

The second signal piece 22 passes through the support plate 122. As shown in FIGS. 5 and 6, one or more strip holes 1221 may be defined in the support plate 122 outside the through hole 1220 as needed; or alternatively, according to the specific structure of the second signal piece 22, the second signal piece 22 may also pass through the support plate 122 via the through hole 1220, that is, the strip hole 1221 can be communicated and merged with the through hole 1220.

Referring to FIGS. 9 and 11, a protrusion portion 211 is limited to a side (lower side) of the pressing block 121 facing the first signal piece 13, and a lower end surface of the second casing 21 is limited to a side (upper side) of the support plate 122 away from the first signal piece 13. Therefore, the protrusion portion 211 as well as the second casing 21 where the protrusion portion 211 is arranged cannot escape from the first casing 11 in the axial direction; and because the second casing 21 is arranged in the mounting hole 120, the second casing 21 cannot escape from the first casing 11 in the radial direction, in this way, the second casing 21 can be fixed on the first casing 11.

It can be understood that a circumferential length of the through hole 1220 should be greater than a circumferential length of the pressing block 121, and the partial area of the through hole 1220 that avoids the pressing block 121 is used for the protrusion portion 211 to pass downward, after the protrusion portion 211 rotates at a certain angle along the circumferential direction, the protrusion portion 211 reaches a position beneath the pressing block 121.

Here, as shown in FIG. 11, it should be noted that an axial distance D is defined as an axial distance between a lower surface of the pressing block 121 and an upper surface of the support plate 122, and an axial distance H is defined as an axial distance between an upper surface of the protrusion portion 211 and a lower end surface of the second casing 211 and a difference between the axial distance D and the axial distance H should be controlled to be very small to avoid the problem that the second casing 21 is easy to shake in the axial direction and is easy to detach from the pressing block 121 and the support plate 122 after rotating reversely along the circumferential direction.

Optionally, the axial distance D is greater than or equal to the axial distance H, so that the second casing 21 and the first casing 11 may be in just contact, thereby reducing the rotation, or even, an interference fit may be formed between the first casing 11 and the second casing 21 (that is, the support plate 122, the pressing block 121, or the protrusion portion 211 may be deformed to a certain extent and compress each other), thereby further reducing rotation.

As shown in FIGS. 4-5, in an embodiment, a lower surface of the pressing block 121 is higher than an upper surface of the support plate 122 or flush with the upper surface of the support plate 122. In other words, the pressing block 121 does not enter the through hole 1220, such that during the manufacture and formation of the cover plate 12, the pressing block 121 inside the mounting hole 120 can be obtained more simply and easily, thereby reducing the manufacturing difficulty and cost of the cover plate 12.

In an optional embodiment, as shown in FIGS. 4-5 and 9, the lower surface of the pressing block 121 is aligned with the upper surface of the support plate 122. Furthermore, a circumferential side wall of the pressing block 121 is arranged close to or even in contact with a circumferential side wall of the through hole 1220. The purpose of such arrangement is that a circumferential inner side wall of the through hole 1220 can be used as a surface for limiting the protrusion portion 211 from further rotation. In this way, the protrusion portion 211 stops when rotating beneath the pressing block 121, and blind operation can be realized by the user during installation of the second casing 21.

In another alternative embodiment, the lower surface of the pressing block 121 is slightly higher than the upper surface of the support plate 122, and a distance between the lower surface of the pressing block 121 and the upper surface of the support plate 122 is smaller than a height of the protrusion portion 211, so as to allow the circumferential inner side wall of the through hole 1220 to be used as a surface for limiting the protrusion portion 211 from further rotation.

Referring to FIGS. 4, 6 and 9, a recess 1210 is formed on a surface of the pressing block 121 facing the protrusion portion 211, a bulge 2110 is formed on a surface of the protrusion portion 211 facing the pressing block 121, and the bulge 2110 is adapted to be accommodated within the recess 1210.

By forming the bulge 2110 and the recess 1210 respectively on the protrusion portion 211 and the pressing block 12, the second casing 21 is further limited from rotation relative to the first casing 11, which further improves the mounting stability of the second casing 21 inside the mounting hole 120.

The height of the bulge 2110 and the depth of the recess 1210 can be designed according to the specific situation. Generally, the height of the bulge 2110 and the depth of the recess 1210 should not be designed to be too large, and should take into account both the low difficulty of rotation and high stability of the assembly.

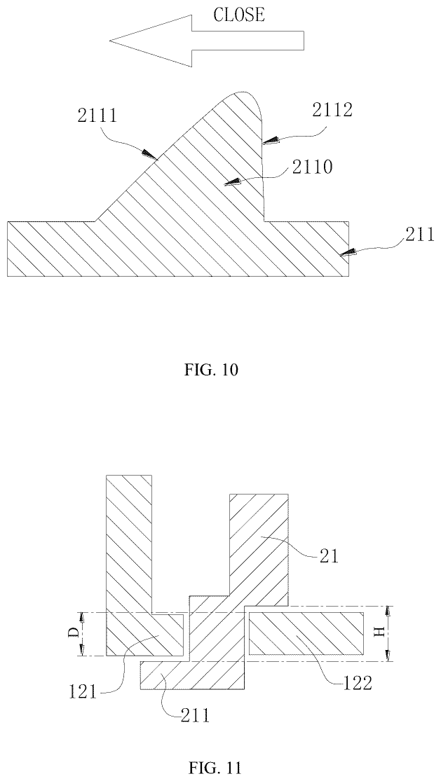

Further referring to FIGS. 6-7, FIG. 9, and FIG. 11, along a tightening rotation direction of second casing 21 (a direction indicated by “CLOSE” in FIG. 4, FIG. 5 and FIG. 10), a front surface of bulge 2110 (that is, a surface that first contacts the pressing block 121 during the tightening process) forms an inclined guide surface 2111, and a rear surface of the bulge 2110 (that is, a surface that contacts the pressing block 121 last during the tightening process) forms a stop surface 2112. A slope change of the guide surface 2111 is relatively gentle, which can guide the bulge 2110 to enter the recess 1210 more smoothly, while a slope change of the stop surface 2112 is relatively large, which has a more obvious effect for blocking the bulge 2110 from releasing the recess 1210.

In order to improve the connection stability and balance between the pressing block 121 and the protrusion portion 211, in an embodiment, a plurality of pressing blocks 121 are provided, and the plurality of pressing blocks 121 are rotationally symmetrically distributed. For example, as shown in FIGS. 4-5, two pressing blocks 121 are symmetrically distributed on the inner wall of the mounting hole 120 in a manner of 180° rotation. Correspondingly, two protrusion portions 211 are symmetrically distributed on the second casing 21 in a manner of 180° rotation.

In addition, a second implementation for the detachable connection between the first casing 11 and the second casing 21 is provided as follows: an inner wall of the mounting hole 120 is provided with an internal thread, and the second casing 21 is provided with an external thread to match with the internal thread of the mounting hole 120.

In more embodiments, the detachable connection between the first casing 11 and the second casing 21 may also be implemented in other ways.

Referring to FIG. 9, in an embodiment, a first convex ring 212 is arranged on an outer peripheral wall of the second casing 21 above the protrusion portion 211, and a first sealing ring 3 is arranged between the first convex ring 212 and the pressing block 121, and the first sealing ring 3 is tightly pressed against the inner peripheral wall of the mounting hole 120. In this way, by means of the first sealing ring 3, a sealing connection between the first casing 11 and the second casing 21 can be achieved, thereby realizing the waterproof function, preventing moisture from entering the first casing 11 from a gap between the second casing 21 and the mounting hole 120, and protecting the internal electronic components inside the second casing 21.

Referring to FIG. 9, in an embodiment, an outer peripheral wall of the second casing 21 is provided with a connecting portion 213 arranged outside the cover plate 12. The connecting portion 213 is used to further connect the second casing 21 and the second signal piece 22 to other structures, for example, to a lamp that require induction control (which is taken as an example hereinbelow, the lamp includes but is not limited to a strip lamp, an industrial and mining lamp, a shoe box lamp, a street lamp, a panel lamp, and a fluorescent lamp) or other devices or other adapting structures. The connecting portion 213 may be a threaded portion and a snap portion, and may be provided as needed.

Further, as shown in FIG. 9, a second sealing ring 4 is arranged between the connecting portion 213 and an upper surface of the cover plate 12. The second sealing ring 4 is used to seal a gap between the connector 2 and the lamp after the connector 2 is connected to the lamp to prevent moisture from entering through the gap and from affecting the conductivity of the second signal piece 22.

In addition, as shown in FIG. 9, a third sealing ring 5 is arranged between the outer peripheral wall of the cover plate 12 and the inner peripheral wall of a top of first accommodation chamber 110. The third sealing ring 5 is used to prevent moisture and the like from entering the first accommodation chamber through the gap between the second casing 21 and the inner peripheral wall of the top of first accommodation chamber 110. Specifically, as shown in FIG. 3, a concave ring 123 may be arranged on the outer peripheral wall of the cover plate 12, and the third sealing ring 5 is pressed between the concave ring 123 and the inner peripheral wall of the top of first accommodation chamber 110.

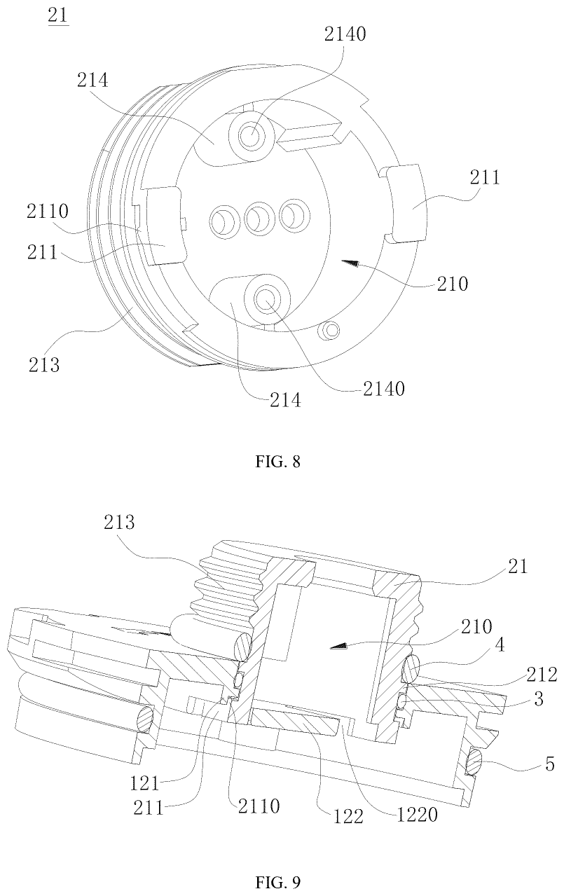

Herein, referring to FIG. 6 and FIG. 7, in order to adapt to or facilitate the installation of different second signal pieces 22 in connectors 2 of different models and specifications, in an embodiment, the connector 2 further includes a fixing plate 23. A side of the second casing 21 facing the first casing 11 is recessed to form a second accommodation chamber 210 (as shown in FIGS. 8-9). The fixing plate 23 is detachably arranged in the second accommodation chamber 210. The fixing plate 23 defines therein one or more fixing holes 231 to allow the signal pieces 22 to pass through, respectively. The second signal pieces 22 further passes through an upper end of the second casing 21, that is, a bottom wall of the second accommodation chamber 210. By means of the multi-point supporting and fitting of the fixing plate 23 and the second casing 21, the assembly stability of the second signal piece 22 on the second casing 21 can be improved.

The number and form of the fixing holes 231 are adapted to the arrangement and shape of the second signal piece 22.

As shown in FIG. 8, a plurality of fixing columns 214 are formed in the second casing 21, that is, on the inner wall of the second accommodation chamber 210; lower ends of the plurality of fixing columns 214 define therein threaded holes 2140, respectively; and the fixing plate 23 defines therein adapting holes 230 at positions corresponding to the threaded hole 2140, respectively (as shown in FIGS. 6-7). The fixing plate 23 can be detachably installed in the second accommodation chamber 210 by passing locking parts such as screws through the adapting holes 230 and the threaded holes 2140. It can be understood that other configurations may be adopted, in other embodiments, the fixing plate 23 can be fixed in the second casing 21 in other manners.

In an embodiment, the sensor body 1 further includes: a power board 14, an induction control board 15, and a sensor 16. The power board 14, the induction control board 15, and the sensor 16 are arranged in the first accommodation chamber. The first signal piece 13 is in electrical connection with the power board 14, the sensor 16 is in electrical connection with the induction control board 15, and the induction control board 15 is in electrical connection with the power board. By adopting the sensor 16 to sense the signal, the power board 14 is controlled to be switched on, and then other devices in connection with the connector 2 are controlled to be turned on.

The specific types of induction control board 15 and the sensor 16 are not limited. Hereinbelow, infrared induction is taken as an example for explanation, in which, the induction control board 15 is an infrared control board, and the sensor 16 is a pyroelectric infrared sensor.

Referring to FIG. 3, the first casing 11 of sensor body 1 is provided therein with a power board 14, an infrared control board 15, a pyroelectric infrared sensor 16, and a Fresnel lens 171. The first signal piece 13 is in electrical connection with the power board 14. The lamp can be turned on for illumination by conducting the current loop in the power board.

The power board 14 is in connection with the infrared control board 15, the pyroelectric infrared sensor 16 is in connection with the infrared control board 15, and the Fresnel lens 171 is fixed on the inner wall of the first casing 11 via a lens pressing piece 172. A light incident surface of the Fresnel lens 171 protrudes from the other end of the first casing 11 (an end opposite to the cover plate 12), and is used to refract an external infrared signal to the pyroelectric infrared sensor 16. When an infrared signal, for example, infrared rays emitted by the human body, is around the sensor body 1 (within a detection range of sensor body 1), the Fresnel lens 171 refracts the infrared signal to the pyroelectric infrared sensor 16. When the pyroelectric infrared sensor 16 is triggered, and the infrared control board 15 receives the trigger signal from the pyroelectric infrared sensor 16, a control signal is generated and forwarded to the power board 14 to control the power board 14 to turn on and the lamp for illumination. On the contrary, when the human body leaves the detection range, the lamp is turned off or is delayed to be turned off.

The power board 14 and the infrared control board 15 are flat-shaped. In order to facilitate arrangement thereof in the first accommodation chamber, the power board 14 and the infrared control board 15 are arranged in parallel and spaced apart, and the power board 14 is arranged close to the first signal piece 13, and the infrared control board 15 is arranged close to the pyroelectric infrared sensor 16 and the Fresnel lens 171. As shown in FIG. 3, the sensor body 1 may include a first connecting piece 191, which electrically and physically connects the power board 14 and the infrared control board 15 in a manner that the first connecting piece 191 substantially vertically passes through the power board 14 and the infrared control board 15. The first connecting piece 191 may be a pin header, for example, a pin header formed of 4 probes with a pitch of 2 mm.

In addition, in an embodiment, the sensor body 1 may also include a Bluetooth control board 181 as needed. For example, in FIG. 3, the Bluetooth control board 181 is arranged between the power board 14 and the infrared control board 15, and is in electrical connection with power board 14 through a second connecting piece 192. The Bluetooth control board 181 is used to communicate with an external Bluetooth module. In this way, the user can send control signals to the Bluetooth control board 181 through the external Bluetooth module, thereby remotely controlling the power board 14 to turn on or turn off. Further, the Bluetooth control board 181 is in electrical connection with the power board 14 through the second connecting piece 192. The second connecting piece 192 may be a pin header, for example, a pin header formed of 9 probes with a pitch of 1.27 mm.

In an embodiment, the sensor body 1 may further include a photosensitive sensor 183 as needed. The photosensitive sensor 183 is arranged in the first accommodation chamber and connected to the power board 14. The photosensitive sensor 183 is used to detect the ambient illumination through an opening defined in the first casing 11. When the ambient illumination is lower than a preset value, the power board 14 is automatically connected to turn on the lamp.

In an embodiment, the sensor body 1 may also include an indicator light 182, as needed, for example, an LED light, which is in electrical connection with the power board 14 for indicating the normal working status of the power board 14.

The above are only preferred embodiments of the present application and are not intended to limit the present application. Any modifications, equivalent substitutions, and improvements made within the spirit and principles of the present application shall be included in the protection scope of the present application.

What is claimed is:

1. A sensor assembly, comprising:
a sensor body, comprising: a first casing, a cover plate, and a first signal piece; and
a connector, comprising: a second casing and second signal piece; wherein
the first casing defines therein a first accommodation chamber;
the cover plate is installed at an end of the first casing;
the first signal piece is arranged in the first accommodation chamber, and the cover plate defines therein a mounting hole in communication with the first accommodation chamber;
the second signal piece is arranged on the second casing, and the second casing is arranged in the mounting hole and is in detachable connection with the cover plate; and
the first signal piece contacts with the second signal piece.

2. The sensor assembly according to claim 1, wherein
a support plate is formed at a bottom of the mounting hole, a pressing block is formed on an inner peripheral wall of the mounting hole, and a through hole is formed in the support plate at a position corresponding to the pressing block;
an end surface of the second casing facing the first casing is provided with a protrusion portion extending radially outwards; and
a protrusion portion presses against a surface of a side of the pressing block facing the first signal piece, and the end surface of the second casing is in contact with a surface of a side of the support plate away from the first signal piece.

3. The sensor assembly according to claim 2, wherein
a distance between the surface of the side of the pressing block facing the first signal piece and the surface of the side of the support plate away from the first signal piece is defined as D,
a distance between a surface of a side of the protrusion portion facing the pressing block and the end surface of the second casing is defined as H, and
D is greater than or equal to H.

4. The sensor assembly according to claim 2, wherein
the surface of the side of the pressing block facing the first signal piece is aligned with the surface of the side of the support plate away from the first signal piece;
or alternatively, the distance between the surface of the side of the pressing block facing the first signal piece and the surface of the side of the support plate away from the first signal piece is greater than 0 and smaller than a height of the protrusion portion.

5. The sensor assembly according to claim 2, wherein a recess is formed on the surface of the side of the pressing block facing the first signal piece, a bulge is formed on the protrusion portion, and the bulge is adapted to be accommodated within the recess.

6. The sensor assembly according to claim 5, wherein along a tightening rotation direction of the second casing, a front surface of the bulge forms an inclined guide surface, and a rear surface of the bulge forms a stop surface.

7. The sensor assembly according to claim 2, wherein
a convex ring is arranged on an outer peripheral wall of the second casing, and the convex ring, and a first sealing ring is arranged in a space enclosed by the convex ring, the pressing block, and an inner peripheral wall of the mounting hole.

8. The sensor assembly according to claim 3, wherein
a convex ring is arranged on an outer peripheral wall of the second casing, and the convex ring, and a first sealing ring is arranged in a space enclosed by the convex ring, the pressing block, and an inner peripheral wall of the mounting hole.

9. The sensor assembly according to claim 4, wherein
a convex ring is arranged on an outer peripheral wall of the second casing, and the convex ring, and a first sealing ring is arranged in a space enclosed by the convex ring, the pressing block, and an inner peripheral wall of the mounting hole.

10. The sensor assembly according to claim 5, wherein
a convex ring is arranged on an outer peripheral wall of the second casing, and the convex ring, and a first sealing ring is arranged in a space enclosed by the convex ring, the pressing block, and an inner peripheral wall of the mounting hole.

11. The sensor assembly according to claim 6, wherein
a convex ring is arranged on an outer peripheral wall of the second casing, and the convex ring, and a first sealing ring is arranged in a space enclosed by the convex ring, the pressing block, and an inner peripheral wall of the mounting hole.

12. The sensor assembly according to claim 1, wherein
an outer peripheral wall of the second casing is provided with a connecting portion arranged outside the cover plate, and a second sealing ring is arranged between the connecting portion and an upper surface of the cover plate;
or alternatively, a third sealing ring is arranged between an outer peripheral wall of the cover plate and an inner peripheral wall of a top of the first accommodation chamber.

13. The sensor assembly according to claim 6, wherein
an outer peripheral wall of the second casing is provided with a connecting portion arranged outside the cover plate, and a second sealing ring is arranged between the connecting portion and an upper surface of the cover plate;
or alternatively, a third sealing ring is arranged between an outer peripheral wall of the cover plate and an inner peripheral wall of the first accommodation chamber.

14. The sensor assembly according to claim 1, wherein
a side of the second casing facing the first casing defines therein a second accommodation chamber, the connector further comprises a fixing plate, and the fixing plate is detachably installed in the second accommodation chamber; and
the fixing plate is defines therein one or more fixing holes to allow the second signal piece to pass through.

15. The sensor assembly according to claim 2, wherein
a side of the second casing facing the first casing defines therein a second accommodation chamber, the connector further comprises a fixing plate, and the fixing plate is detachably installed in the second accommodation chamber; and
the fixing plate is defines therein one or more fixing holes to allow the second signal piece to pass through.

16. The sensor assembly according to claim 3, wherein
a side of the second casing facing the first casing defines therein a second accommodation chamber, the connector further comprises a fixing plate, and the fixing plate is detachably installed in the second accommodation chamber; and
the fixing plate is defines therein one or more fixing holes to allow the second signal piece to pass through.

17. The sensor assembly according to claim 6, wherein
a side of the second casing facing the first casing defines therein a second accommodation chamber, the connector further comprises a fixing plate, and the fixing plate is detachably installed in the second accommodation chamber; and
the fixing plate is defines therein one or more fixing holes to allow the second signal piece to pass through.

18. The sensor assembly according to claim 1, wherein
the sensor body further comprises: a power board, an induction control board, and a sensor;
the power board, the induction control board, and the sensor are arranged in the first accommodation chamber; and
the first signal piece is in electrical connection with the power board, the sensor is in electrical connection with the induction control board, and the induction control board is in electrical connection with the power board.

19. The sensor assembly according to claim 2, wherein
the sensor body further comprises: a power board, an induction control board, and a sensor;
the power board, the induction control board, and the sensor are arranged in the first accommodation chamber; and
the first signal piece is in electrical connection with the power board, the sensor is in electrical connection with the induction control board, and the induction control board is in electrical connection with the power board.

20. The sensor assembly according to claim 6, wherein
the sensor body further comprises: a power board, an induction control board, and a sensor;
the power board, the induction control board, and the sensor are arranged in the first accommodation chamber; and
the first signal piece is in electrical connection with the power board, the sensor is in electrical connection with the induction control board, and the induction control board is in electrical connection with the power board.
